(19) United States
(12) Patent Application Publication
(10) Pub. No.: US 2011/0015938 A1
(43) Pub. Date: Jan. 20, 2011

(54) PREOPERATIVE SURGICAL TIME OUT PROCEDURE FEATURE INCORPORATED INTO A SURGICAL SPECIALTY INSTRUMENT

(76) Inventors: Lawrence Rabinowitz, Alpine, NJ (US); Richard Jonathan Mackool, Pelham Manor, NY (US)

Correspondence Address: HESS PATENT LAW FIRM, P.C., 9 MIRAMAR LANE, STAMFORD, CT, 06902, US

(21) Appl. No.: 12/836,550

(22) Filed: Jul. 14, 2010

Related U.S. Application Data
(60) Provisional application No. 61/226,814, filed on Jul. 20, 2009.

(51) Int. Cl. G06Q 50/00; G06F 3/048; G06F 13/12; G06Q 10/00

(52) U.S. Cl. 705/2; 715/764; 710/74

(57) ABSTRACT

A surgical specialty instrument or equipment has a user interface (e.g., USB port, magnetic card stripe reader, wireless transceiver). A data entry device (e.g., scanner, microphone) may supply information pertinent to a preoperative surgical time out procedure via the user interface for storage. A data output device (e.g., printer, display screen) may retrieve an indication pertaining to preoperative surgical time out procedure via the user interface and/or retrieve the pertinent information.

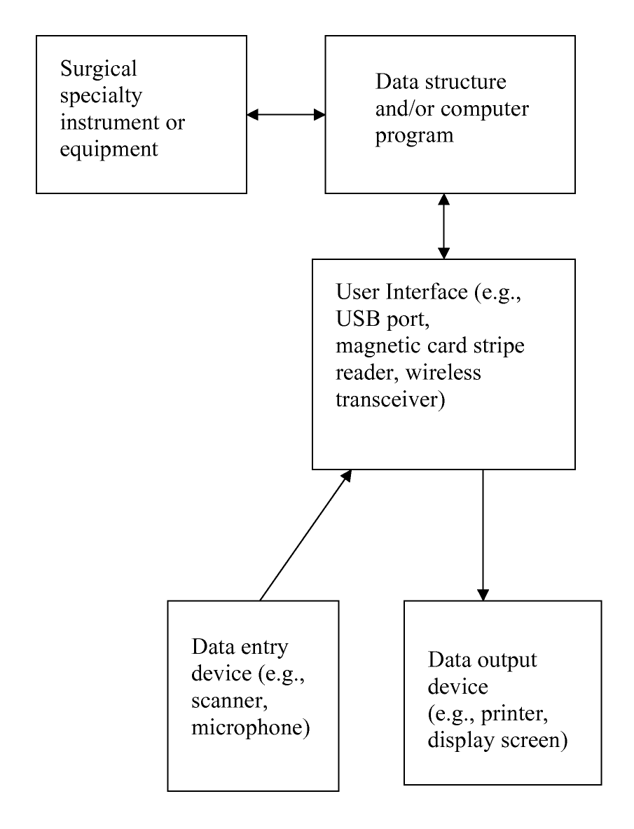

### CROSS-REFERENCE TO COPENDING PATENT APPLICATION

This application claims the benefit of priority from provisional patent application Ser. No. 61/226,814 filed Jul. 20, 2009.

### BACKGROUND OF THE INVENTION

1. Field of the Invention

The present invention relates the incorporation of a preoperative surgical time out procedure feature into a surgical specialty instrument that is to be used in carrying out the surgical procedure after the preoperative surgical time out procedure is successfully completed.

2. Discussion of Related Art

In the United States, surgical specialties now have mandated timeout periods to be observed prior to carrying out all surgical procedures. Each of the various surgical specialties has their own surgical equipment and surgical instruments. There are several classes of surgical instruments and equipment:

Graspers, such as forceps
Clamps and occluders for blood vessels and other organs
Retractors, used to spread open skin, ribs and other tissue
Distractors, positioners and stereotactic devices
Mechanical cutters (scalpels, lancets, drill bits, rasps, trocars, etc.)
Dilators and specula, for access to narrow passages or incisions
Suction tips and tubes, for removal of bodily fluids
Irrigation and injection needles, tips and tubes, for introducing fluid
Tyndallers, to help “wedge” open damaged tissues in the brain.
Powered devices, such as drills, dermatomes
Scopes and probes, including fiber optic endoscopes and tactile probes
Carriers and appliers for optical, electronic and mechanical devices
Ultrasound tissue disruptors, cryotomes and cutting laser guides
Measurement devices, such as rulers and calipers
Monitoring devices, such as cardiac, blood pressure and respiration monitors

Typically, practitioners rely upon a computer-readable medium encoded with either a data structure or a computer program that assists with the control or operation of the applicable equipment and instruments. In many cases a user interface is provided that allows the practitioner/user to interact with the computerized control or operation in order to manipulate the data structure or computer program in some manner, such as by entering information to be processed by the data structure and/or computer program, and allowing the computer interface to indicate the effects of the user's manipulation (such as via a print-out from a printer and/or display screen).

There are many different types of user interfaces in use in many different kinds of applications. Equipment or instruments used in any of the surgical specialties that operate in part under guidance from such a data structure or computer program may be equipped with any kind of user interface in accordance with the invention. The following are examples of suitable user interfaces, but the list is not exhaustive—other kinds of user interfaces not listed but are envisioned as applicable as well:

Graphical user interfaces (GUI) accept input via devices such as computer keyboard and mouse and provide articulated graphical output on the computer monitor. There are at least two different principles widely used in GUI design: Object-oriented user interfaces (OOUIs) and application oriented interfaces.

Web-based user interfaces or web user interfaces (WUI) accept input and provide output by generating web pages that are transmitted via the Internet and viewed by the user using a web browser program. Newer implementations utilize Java, AJAX, Adobe Flex, Microsoft .NET, or similar technologies to provide real-time control in a separate program, eliminating the need to refresh a traditional HTML based web browser. Administrative web interfaces for web-servers, servers and networked computers are often called Control panels.

Command line interfaces permit the user to provide input by typing a command string with the computer keyboard and the system provides output by printing text on the computer monitor that can be used for system administration tasks etc.

Tactile interfaces supplement or replace other forms of output with haptic feedback methods and can be used in computerized simulators etc.

Touch user interface is a graphical user interface, using a touchscreen display as a combined input and output device. They are used in many types of point of sale, industrial processes and machines, self-service machines etc.

Attentive user interfaces manage the user attention, decide when to interrupt the user, the type of warnings, and the level of detail of the messages presented to the user.

Batch interfaces are non-interactive user interfaces, where the user specifies all the details of the batch job in advance to batch processing, and receives the output when all the processing is done. The computer does not prompt for further input after the processing has started.

Conversational Interface Agents attempt to personify the computer interface in the form of an animated person, robot, or other character (such as Microsoft's Clippy the paperclip), and present interactions in a conversational form.

Crossing-based interfaces are graphical user interfaces in which the primary task consists in crossing boundaries instead of pointing.

Gesture interface are graphical user interfaces which accept input in a form of hand gestures, or mouse gestures sketched with a computer mouse or a stylus.

Intelligent user interfaces are human-machine interfaces that aim to improve the efficiency, effectiveness, and naturalness of human-machine interaction by representing, reasoning, and acting on models of the user, domain, task, discourse, and media (e.g., graphics, natural language, gesture).

Motion tracking interfaces monitor the user's body motions and translate them into commands, currently being developed by Apple, Inc.

Multi-screen interfaces, employ multiple displays to provide a more flexible interaction. This is often employed in computer game interaction in both the commercial arcades and more recently the handheld markets.

Noncommand user interfaces, which observe the user to infer his/her needs and intentions, without requiring that he/she formulate explicit commands.

Object-Oriented User Interface (OOUI)

Reflexive user interfaces where the users control and redefine the entire system via the user interface alone, for instance to change its command verbs. Typically this is only possible with very rich graphic user interfaces.

Tangible user interfaces, which place a greater emphasis on touch and physical environment or its element.

Text user interfaces are user interfaces, which output text, but accept other form of input in addition to or in place of typed command strings.

Voice user interfaces, which accept input and provide output by generating voice prompts. The user input is made by pressing keys or buttons or by responding verbally to the interface.

Natural-Language interfaces—Used for search engines and on webpages. User types in a question and waits for a response.

Zero-Input interfaces get inputs from a set of sensors instead of querying the user with input dialogs.

Zooming user interfaces are graphical user interfaces in which information objects are represented at different levels of scale and detail, and where the user can change the scale of the viewed area in order to show more detail.

Efforts have been proposed to ensure compliance with preoperative surgical time out procedures. However, those efforts generally rely on user interfaces that are remote from surgical specialty instruments and require some integration either to the instruments themselves or to a facility's power supply in order to render the instruments inoperative during the preoperative surgical time out procedure.

Surgeons are trained to operate surgical specialty instruments in the course of their professional duties. Surgeons are also ultimately responsible for ensuring proper completion of preoperative surgical time out procedures. However, they may not be familiar with a surgical facility's remote user interfaces that provide access to preoperative surgical time out procedures and thus may have to rely upon trained staff of the surgical facility to assist, particularly if the surgeon is new to the facility.

Further, if the preoperative surgical time out procedure at a particular facility varies depending upon the specialty surgery, then the user of the remote user interface would need to identify the appropriate one. There would be no dedicated preoperative surgical time out procedure that would automatically be presented to the user, because the user needs to select the one that applies.

In addition, the facility needs to make resources available to document the performance of preoperative surgical time out procedures via such a remote user interface.

It is desired to ensure compliance with preoperative surgical time out procedures via user interfaces of surgical specialty instruments and equipment. Because the surgical specialty instruments and equipment are typically used only for a limited number of specialty surgeries, the preoperative surgical time out procedure can be made specific to those surgical specialty instruments and equipment and the surgeon would already be familiar with their operation and procedures from the surgeon's previous training on using the surgical specialty instruments and equipment. Also, where the surgical specialty instruments and equipment are equipped themselves with memory to record the preoperative surgical time out procedure, the medical facility would not need to devote resources to do so at least for short term storage.

In addition, field surgeons, who perform surgical operations at makeshift medical facilities such as those set up in remote areas or at a field hospital, should likewise comply with preoperative surgical time out procedures. Field surgeons would find it easier to ensure compliance with a dedicated preoperative surgical time out procedure that was “built-in” to the surgical specialty instrument to be used and that the field surgeon was already familiar with, rather than try to integrate a remote user interface (that needs to be set up to provide access to a preoperative surgical time out procedure) into the makeshift medical facility's electrical supply to render inoperative the specialty surgical instruments and equipment until the preoperative surgical time out procedure is completed.

### SUMMARY OF THE INVENTION

One aspect of the present invention relates to a preoperative surgical time out procedure feature incorporated into a surgical specialty instrument. The instrument is equipped with a user interface and configured to provide access for storage and retrieval of information pertinent to a preoperative surgical time out procedure. A data entry device may be in communication with the user interface to provide the information for the storage. A data output device may be in communication with the user interface to receive the information from the storage and to make an indication of the received information.

Preferably, a computer readable data structure is incorporated into the surgical specialty equipment that enables access, retrieval, receipt and storage of the preoperative surgical time out procedure information. Such information includes a patient's name, date of birth, social security number, address, identification number for either the medical practice or the surgical facility, surgical or other procedure planned, organ and surgical site, name of procedure, and any combination thereof.

The surgical specialty instrument may be equipped with computer programming to analyze information entered via a data entry device in response to the preoperative surgical time out procedure to check whether an entry was made for each item in a checklist of items needed to complete the preoperative surgical time out procedure. The checklist may be stored in memory of the surgical specialty instrument.

### BRIEF DESCRIPTION OF THE DRAWING

For a better understanding of the present invention, reference is made to the following description and accompanying drawings, while the scope of the invention is set forth in the appended claims.

The drawing is a schematic showing the manner in which the various components of the invention communicate with each other.

### DESCRIPTION OF THE PREFERRED EMBODIMENT

Turning to the drawing, the following five components are identified in communication with each other: (a) surgical specialty instrument or equipment, (b) data structure and/or computer program, (c) user interface (e.g., USB port, magnetic card stripe reader, wireless transceiver), (d) data entry device (e.g., scanner, microphone); and (e) data output device (e.g., printer, display screen). The purpose for the communication in accordance with the invention is to process specific information pertinent to completion of a preoperative surgical time out procedure.

The surgical specialty instrument or equipment that has application to the present invention include all the various types of surgical specialty instruments or equipment are set forth in the Background of the Invention of this patent application provided such surgical specialty instrument or equipment either is equipped with a user interface mechanism of any of the kinds also mentioned in the Background of the Invention of this patent application or is otherwise controlled under the direction of software, firmware or chip hardware.

The user interface mechanism that is used to enter the specific information necessary to complete the preoperative surgical time out procedure may include that based on the internet, various wireless handheld devices, PDA, CD-ROM, various types of memory chips, smart cards, and various scanning devices that could quickly glean the information and transmit it to the surgical specialty instrument or equipment. For instance, the user interface mechanism could be a simple bar code scanning device, other scanners that are capable of transmitting data into the instrument software, etc.

Indeed, the surgical specialty instrument or equipment could be rendered inoperative or dysfunctional unless such specific information pertinent to completion of the preoperative surgical time out procedure is entered appropriately and acknowledged by the instrument's operator. The surgical specialty instrument or equipment could also emit a warning signal if all of the required specific information has not been completed during various points in time, in addition to keeping the specialty instrument or equipment inoperative until all the specific information is received to complete the preoperative surgical time out procedure.

Further, the present invention is directed in part to modifying the operation of surgical specialty instruments and equipment that operate under direction of a computer-readable medium encoded with (1) a data structure that defines structural and functional interrelationships between the data structure and the computer software and hardware components, and/or (2) a computer program that defines structural and functional interrelationships between the computer program and the rest of the computer.

In particular, the present invention is directed to modifying surgical specialty instruments to provide them with any desired user interface (if they do not currently possess that desired user interface) and to modify the data structure and/or computer program to provide any one, any group, or all of the following capabilities:
a. Access, retrieve, receive and/or store information pertaining to include any or all of the following: patient's name, date of birth, social security number, address, identification number (for either the medical practice and/or the surgical facility), surgical or other procedure planned, organ and surgical site (e.g. right arm, left eye, etc.), name of procedure e.g. amputation of right foot, cataract extraction of left eye, etc.
b. Send commands to print out the information pertaining to any or all of the following: patient's name, date of birth, social security number, address, identification number (for either the medical practice and/or the surgical facility), surgical or other procedure planned, organ and surgical site (e.g. right arm, left eye, etc.), name of procedure e.g. amputation of right foot, cataract extraction of left eye, etc.
c. Send commands to print out preoperative timeout checklists, such as that exemplified by the accompanying form entitled Preoperative/treatment verification checklist.
d. Modify the commands in the future as to what information to print out to accommodate additional information that may be required in the future as new procedures are developed.
e. Emit a warning signal if all of the required fields in a timeout checklist have not been completed. To achieve this, the checklist may need to be scanned and evaluated by a computer processor as to whether the required fields have been completed. Otherwise, such a decision may be left to the discretion of the persons in charge of the surgical specialty procedure who will need to utilize the user interface to enter an indication that all the required fields are complete.
f. Prevent operation of the surgical specialty instrument or equipment in connection with carrying out the next planned surgical procedure unless and until the preoperative timeout procedure is completed, at least as reflected by information entered through the user interface by the person(s) in charge of surgical specialty procedure.
g. Scan biometrics, such as a fingerprint, backhand vein, finger vein, wrist vein, palm, iris, ear shape, or lip shape to identify the patient by comparing to match with biometrics of the patient that were stored prior to the patient entering the operating room. This verifies the identity of the patient and assures that the patient will receive the intended surgical procedure.
h. Scan barcode or RFID on the patient's medical bracelet, for instance, and verify hat the information corresponds to that which was previously stored. This verifies the identity of the patient and assures that the patient will receive the intended surgical procedure.
i. Require an acknowledgement via the user interface that all the appropriate personnel noted the patient information as correct and/or that a printout was obtained before the data structure or computer program allows the surgical specialty instrument or equipment to operate to carry out the surgical specialty procedure. Because of the privileged nature of this information, operator pass codes may be necessary in order to access and/or enter information from or into the system.
j. Audibly record (with a conventional microphone) the timeout procedure to store the same or any part thereof directly into memory of the surgical specialty instrument or equipment, such as whether the patient says his/her name and birthday (i.e., 2 identifiers of a preoperative timeout procedure) as well as the type of surgery and body side (left or right) twhere the surgical procedure is to be performed. The recorded audio of speech from the patient, physician and/or staff in furtherance of completing the timeout procedure would be entered as data. The physician/staff may then confirm the information in order to “unlock” that requirement and in effect permit operation of the surgical specialty instrument or equipment, subject to completion of the remainder of the preoperative timeout procedure.

The scan for biometrics, barcode or RFID is carried out with an appropriate conventional scanner. In accordance with the invention, the scanner may be integral with the surgical specialty device, but need not be. Instead, such a scanner may be a remote scanning device that is either plugged into the surgical specialty instrument or equipment, wirelessly in communication with the surgical specialty instrument or equipment, or is communication via the Internet or an Intranet with the surgical specialty instrument.

Alternatively, the scanner may be equipped with a removable memory card or a memory chip device into which is downloaded that which was scanned—the removable memory card or chip is configured for insertion into the surgical specialty instrument or equipment to download its contents. For instance, the surgical specialty instrument may have a user interface configure to read a magnetic stripe of the removable memory card or be a USB port into which is plugged the memory chip device.

As a further alternative, the scanner may be in wireless connection (such as via Bluetooth frequencies) through a transceiver equipped as a user interface with the surgical specialty instrument. Otherwise, the surgical specialty instrument may be connected directly or via the Internet or an Intranet with the scanner, either via plugged connections or wirelessly.

The surgical specialty instrument could be equipped with its own printer or in communication with an external remote printer to print a hard copy of the information. The copy could then be signed/initialed by those individuals who were required to participate in the timeout. As in the case for the scanner, the printer may be in communication with the surgical specialty instrument either directly, through an Internet or Intranet, or wirelessly via Bluetooth frequencies.

The surgical specialty instrument itself could be equipped with audio recording capability to record the entire time out procedure (or any part thereof) and store it together with the date and time. However, medical facilities generally require that paper records be generated and signed and dated by physicians/staff involved in the specialty surgery procedure, which means the recorded audio would need to be transcribed into a printed transcript. Such a printed transcript is likely preferred by medical facilities for reasons of storage, potential aging, less chance of loss, etc. Conventional voice recognition software would provide a written transcript of the recorded audio to be printed out for the preoperative timeout procedure for signature and storage.

At least some of the surgical specialty instrument print out checklists should be filled out before or during the preoperative timeout. And if not filled out, then the operator entering the info would be informed of this. Even if a particular field in a checklist is not relevant to the procedure, an entry such as “Not applicable” would be needed to be treated as filled in to proceed further. Indeed, the surgical instrument software may help fill out the checklists, perhaps through a verification procedure with operating room personnel. Thus, “not applicable” would need to be entered in a particular field not relevant to the procedure in order to continue with uploading information to complete the checklist.

If desired, the surgical specialty instrument or equipment may be equipped to verbalize (via a voice chip) some of what personnel reported in the video, such as the patient's recent medical history, allergies, on-going medication, etc. As currently required, however, all personnel involved must stop what they are doing during the “timeout”. The instrument may verbalize scanned information (such as the patient ID information based on scanning biometrics, barcode or RFID).

An important distinction over conventional preoperative timeout procedures that rely upon the spoken word to verify the data is that the present invention supplements the spoken word with electronic memory storage and retrieval of data. The reliance on just the spoken word is obviously a potential source of error as hearing impairment/voice recognition/accents, etc could lead to incorrect relay of information. Viewing the material on a screen, with audio verification if desired, reduces the likelihood of error as does a print-out of the recorded information.

If desired, the specialty surgical instrument may be equipped with a dedicated switch and commands to initiate storage of information pertinent to the preoperative surgical time out procedures so as to segregate its storage from other kinds of stored information. For instance, the information may be data based (swiped from a magnetic stripe), text based (via a PDA keyboard) and voice based (via a microphone) to complete the same preoperative surgical time out procedure for a particular patient and the patient's particular surgery. All such entered information (data, text, video, voice) specific to that patient and the patient's particular surgery may be associated together such as by linking to unique identifying indicia. That way, all the pertinent information, of whatever form, is stored and readily retrievable in total for inspection simply by reviewing the information that is associated together.

While the foregoing description and drawings represent the preferred embodiments of the present invention, it will be understood that various changes and modifications may be made without departing from the scope of the present invention.

What is claimed is:

1. A preoperative surgical time out procedure apparatus, comprising:
a surgical specialty instrument equipped with a user interface and configured to provide access via the user interface for storage and retrieval of information pertinent to a preoperative surgical time out procedure that is to be completed before a specialty surgery is performed with the specialty surgery instrument.

2. The apparatus of claim 1, wherein the user interface is selected from a group consisting of a USB port, a magnetic card stripe reader, a wireless transceiver, a CD-ROM reader, smart card reader, and a memory chip reader.

3. The apparatus of claim 1, wherein the user interface is selected from a group consisting of graphical, web-based, command line, tactile, touch, attentive, conversational, crossing-based, gesture, intelligent, motion tracking, multi-screen, noncommand, object oriented, reflexive, tangible, text, voice, natural language, zero-input, and zooming.

4. The apparatus of claim 1, further comprising
a data entry device in communication with the user interface to provide the information for the storage; and
a data output device in communication with the user interface to receive the information from the storage and to make an indication of the received information.

5. The apparatus of claim 4, wherein the data entry device is selected from a group consisting of a barcode scanner, RFID scanner, biometrics scanner, microphone, keyboard, mouse, touch screen, web browser, personal digital assistant device, and wireless handheld computer. CD-ROM, memory chips, smart cards, and Internet based.

6. The apparatus of claim 4, wherein the data output device is selected from a group consisting of a printer, a display screen and a speaker.

7. The apparatus of claim 1, wherein the specialty surgical instrument is equipped with a computer readable data structure that enables access, retrieval, receipt and storage of the information pertinent to completion of the preoperative surgical time out procedure, the information being selected from a group consisting of patient's name, date of birth, social security number, address, identification number for either the medical practice or the surgical facility, surgical or other procedure planned, organ and surgical site, name of procedure, and any combination thereof.

8. The apparatus of claim 1, wherein the specialty surgical instrument is equipped with storage that contains a checklist for completion of the preoperative surgical time out procedure, the specialty surgical instrument being configured to access a data output device to make an indication signifying omissions of information in the stored checklist that render incomplete the preoperative surgical time out procedure.

9. The apparatus of claim 8, wherein the specialty surgical instrument is further configured to be inoperative for carrying out the specialty surgery to be performed with the specialty surgical instrument as long as the omissions remain.

10. The apparatus of claim 1, wherein the storage is part of the surgical specialty instrument.

11. The apparatus of claim 1, wherein the surgical specialty instrument is equipped with a further interface that provides remote access to the storage.

12. The apparatus of claim 1, wherein the surgical specialty instrument is configured to associate together the information pertinent to the preoperative surgical time out procedure, even if the pertinent information is in multiple forms selected from a group consisting of being data based, text based, video based, voice based and any combination thereof.

13. The apparatus of claim 1, wherein the surgical specialty instrument is equipped with devices selected from a group consisting of graspers, clamps and occluders, retractors, distractors, positioners, stereotactic devices, mechanical cutters, scalpels, lancets, drill bits, rasps, trocars, dilators, specula, suction tips, suction tubes, irrigation needles, injection needles, tyndallers, powered drills, powered dermatomes, scopes, probes, fiber opic endoscopes, tactile probes, carriers, ultrasound tissue disruptors, cryotomes, cutting laser guides, measurement devices, rulers, calipers, monitoring devices, cardiac monitors, blood pressure monitors, respiration monitors, and any combination thereof.

14. A method of carrying out a preoperative surgical time out procedure, comprising:
accessing a user interface of a surgical specialty instrument to store information pertinent to a preoperative surgical time out procedure and to obtain an indication pertinent to the preoperative surgical time out procedure;
completing the preoperative surgical time out procedure; and
performing a specialty surgery with the surgical specialty instrument subsequent to the completing of the preoperative surgical time out procedure.

15. The method of claim 14, wherein the surgical specialty instrument is equipped with a computer readable data structure that enables access, retrieval, receipt and storage of the information pertinent to the preoperative surgical time out procedure, the information being selected from a group consisting of patient's name, date of birth, social security number, address, identification number for either the medical practice or the surgical facility, surgical or other procedure planned, organ and surgical site, name of procedure, and any combination thereof.

16. The method of claim 14, wherein the surgical specialty instrument accesses a stored checklist for completion of the preoperative surgical time out procedure, the specialty surgical instrument accessing a data output device to make the indication, the indication signifying omissions of information in the stored checklist that render incomplete the preoperative surgical time out procedure.

17. The method of claim 14, further comprising equipping the surgical specialty instrument with devices selected from a group consisting of graspers, clamps and occluders, retractors, distractors, positioners, stereotactic devices, mechanical cutters, scalpels, lancets, drill bits, rasps, trocars, dilators, specula, suction tips, suction tubes, irrigation needles, injection needles, tyndallers, powered drills, powered dermatomes, scopes, probes, fiber opic endoscopes, tactile probes, carriers, ultrasound tissue disruptors, cryotomes, cutting laser guides, measurement devices, rulers, calipers, monitoring devices, cardiac monitors, blood pressure monitors, respiration monitors and any combination thereof.

18. The method of claim 14, further comprising associating together the stored information pertinent to completing the preoperative surgical time out procedure, even if the pertinent information is in multiple forms selected from a group consisting of being data based, text based, video based, voice based and any combination thereof.

19. A method of carrying out a preoperative surgical time out procedure, comprising:
accessing a user interface of a surgical specialty instrument to store information pertinent to completing a preoperative surgical time out procedure and to obtain an indication pertinent to the completion of the preoperative surgical time out procedure;
analyzing the stored information to assess an extent that the preoperative surgical time out procedure is complete; and
rendering inoperative the surgical specialty instrument for performing a specialty surgery as long as the analyzing assess that the stored information falls short of completion of the preoperative surgical time out procedure.

20. The method of claim 19, further comprising equipping the surgical specialty instrument with devices selected from a group consisting of graspers, clamps and occluders, retractors, distractors, positioners, stereotactic devices, mechanical cutters, scalpels, lancets, drill bits, rasps, trocars, dilators, specula, suction tips, suction tubes, irrigation needles, injection needles, tyndallers, powered drills, powered dermatomes, scopes, probes, fiber opic endoscopes, tactile probes, carriers, ultrasound tissue disruptors, cryotomes, cutting laser guides, measurement devices, rulers, calipers, monitoring devices, cardiac monitors, blood pressure monitors, respiration monitors and any combination thereof.

21. The method of claim 19, further comprising associating together the stored information pertinent to completing the preoperative surgical time out procedure, even if the pertinent information is in multiple forms selected from a group consisting of being data based, text based, video based, voice based and any combination thereof.
